(19) United States
(12) Patent Application Publication
(10) Pub. No.: US 2014/0309900 A1
(43) Pub. Date: Oct. 16, 2014

(54) System and Method for Controlling an Electronic Parking Brake System

(71) Applicant: BENDIX COMMERCIAL VEHICLE SYSTEMS LLC, Elyria, OH (US)

(72) Inventors: Timothy J. Frashure, Columbia Station, OH (US); Daniel P. Zula, North Ridgeville, OH (US); David J. Taneyhill, Elyria, OH (US)

(73) Assignee: Bendix Commercial Vehicle Systems LLC, Elyria, OH (US)

(21) Appl. No.: 13/863,813

(22) Filed: Apr. 16, 2013

(51) Int. Cl. B60T 17/22; B60T 8/17

(52) U.S. Cl. CPC B60T 17/22; B60T 8/17
USPC 701/70; 701/34.4

(57) ABSTRACT

Various embodiments of a system and method of controlling an electronic parking brake system for an air braked vehicle are disclosed. A dash switch module receives a signal indicative of a parking brake request. The dash switch module transmits a parking brake control message using a first communication path in response to the parking brake request. A braking system controller transmits a check message in response to the parking brake control message using a second communication path. The dash switch module transmits a confirmation message using the second communication path in response to the confirmation message. The brake system controller transmits a control signal to the park control module to park or un-park the vehicle in response to the confirmation message.

### FIELD OF THE INVENTION

The present invention relates to embodiments of a system and method for controlling an electronic parking brake system on a commercial vehicle equipped with air brakes.

### BACKGROUND

Typical air brake parking systems require an air valve and pneumatic tubing in the dashboard of a commercial vehicle to equip the operator to manually actuate or release the parking brakes of the vehicle. A brake actuator, such as the Eversure® brake actuator from Bendix Commercial Vehicle Systems LLC, requires positive air pressure to release the internal power spring in the parking brake housing portion of the brake actuator to un-park the vehicle. An electronic parking brake system replaces the dash mounted air valve, bulky pneumatic plumbing and multiple downstream air control devices with a configuration of electronic switches, controllers and electro-pneumatic devices. Actuation and release timing, reliability and range of functionality can be improved with the use of the electronic parking brake system. The switches, controllers and electro-pneumatic devices of the electronic parking brake system may communicate directly with each other or use a serial communication bus.

The hard wired serial communication bus on a commercial vehicle serves as the communication path for many controllers on the vehicle, including the engine controller, the HVAC controller and the transmission controller as well as the controllers associated with the electronic parking brake system. The serial communication bus complexity increases with the number of controllers; each controller requiring a high level of interaction with other system controllers in order to function properly. The serial communication bus may be subject to faults due to overloading or wiring malfunctions.

### SUMMARY

Various embodiments of a system for controlling an electronic parking brake system are disclosed. In accordance with one aspect, the electronic parking brake system comprises a dash switch controller and a brake system controller. The dash switch controller comprises a processing unit that is capable of: receiving a signal indicative of a parking brake request, transmitting a parking brake control message in response to the signal indicative of a parking brake request being received, receiving a check message subsequent to the parking brake control message being transmitted and transmitting a confirmation message in response to the check message. The brake system controller is communicatively coupled to the dash switch controller. The brake system controller comprises a processing unit that is capable of receiving a parking brake control message, and transmitting a check message in response to the parking brake control message being received.

In one embodiment, the brake system controller comprises a first port in electrical communication with a first communication path and a second port in electrical communication with a second communication path. The brake system controller includes a third port for transmitting a control signal to a park control module. The brake system controller includes control logic which receives a parking brake control message via the first communication path; transmits a check message via the second communication path; and receives a confirmation message via the second communication path prior to transmitting the control signal to the park control module.

In another embodiment, the dash switch controller comprises a first port in electrical communication with a first communication path and a second port in electrical communication with a second communication path. The dash switch controller includes a third port for receiving a signal indicative of a parking brake request. The dash switch controller includes control logic which receives the parking brake request through the third port; transmits a parking brake control message in response to the parking brake request via the first communication path; receives a check message via the second communication path and transmits a confirmation message via the second communication path.

In accordance with another aspect, a method for controlling an electronic parking brake system includes receiving in a dash switch controller a parking brake request and transmitting a parking brake control message from the dash switch controller to the brake system controller through a first communication path in response to the parking brake request. The method further includes transmitting a check message from the brake system controller to the dash switch controller using a second communication path in response to the parking brake control message, wherein the first communication path is different than the second communication path. The method further includes transmitting a confirmation message from the dash switch controller to the brake system controller using the second communication path in response to the check message.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of an electronic parking brake system, including an dash switch controller and a brake system controller, according to an embodiment of the present invention;

FIG. 2 illustrates a flowchart that describes a method of implementing the electronic parking brake control for actuating the parking brakes, according to an embodiment of the present invention; and

FIG. 3 illustrates a flowchart that describes another method of implementing the electronic parking brake control for releasing the parking brakes, according to an embodiment of the present invention.

### DETAILED DESCRIPTION

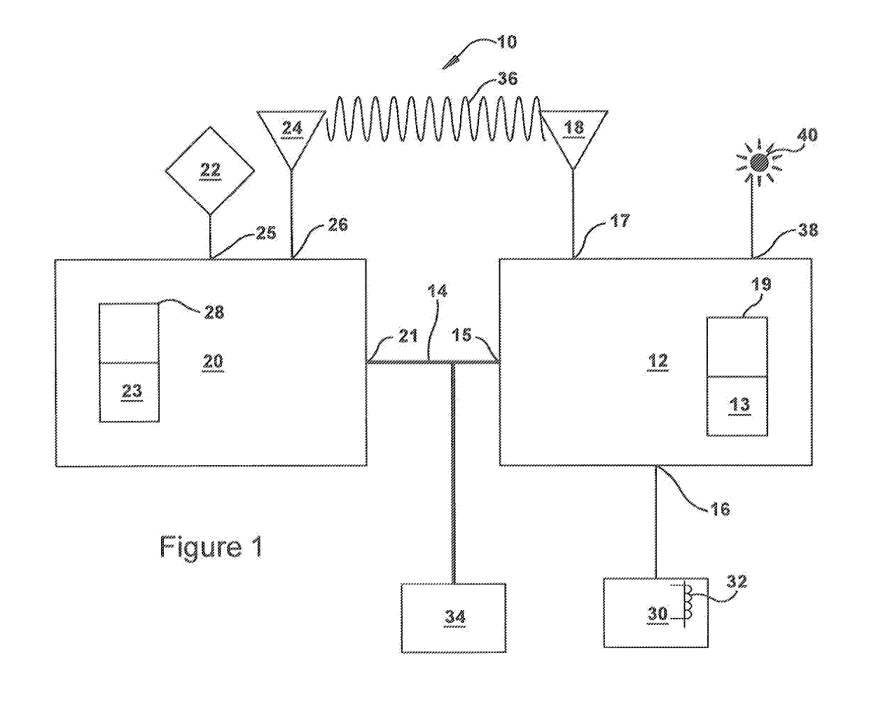

With reference to FIG. 1, an electronic parking brake system 10 for use in electronically controlling the parking of an air braked vehicle, such as a tractor or non-towing truck, is shown. The system 10 includes a dash switch controller 20 and a brake system controller 12. The dash switch controller 20 initiates requests for parking brake system actuation and release in response to inputs from an external source, for example, the vehicle operator. The brake system controller 12 is equipped to enable the actuation and release of the parking brakes on the vehicle while also managing antilock braking system and/or electronic stability control functions. The system 10 may also include a park control module 30 that is capable of actuating and releasing the parking brakes by transmitting a pneumatic signal in response to an electrical signal. In system 10, the dash switch controller 20 and the brake system controller 12 communicate in order to actuate and release the parking brakes on the vehicle.

The electronic parking brake system 10 includes a first communication path 14 between the dash switch controller 20 and the brake system controller 12. The dash switch controller 20 and the brake system controller 12 are electrically connected to the first communication path 14. The first communication path 14 enables bidirectional communication with other controllers electrically connected to the communication path 14, such as vehicle controller 34. In one embodiment, the first communication path 14 is a hard-wired communication path, for example a serial communication bus. The serial communication bus may be arranged to carry out communications according to an industry standard protocol, including but not limited to SAE J1939, or a proprietary bus protocol. A proprietary bus protocol uses messages that are proprietary to the manufacturer of the controllers that are connected to the serial communication bus. Controllers made by a different manufacturer may be able to receive the proprietary messages but would not be able to interpret a proprietary message. A discrete hard-wired logic line could alternatively be used as the first communication path.

The electronic parking brake system 10 includes a second communication path 36 between the dash switch controller 20 and the brake system controller 12. The dash switch controller 20 and the brake system controller 12 are capable of communicating using the second communication path 34. In one embodiment, the second communication path 36 is a wireless path. The wireless path may be arranged to carry out communications according to an industry standard protocol, including but not limited to RKE, Zigbee, Bluetooth or IEEE 802.11. Robust transmission between the dash switch controller and the brake system controller of the operator's intent to actuate or release the parking brakes is desired in order to prevent inadvertent actuation or release of the parking brakes.

The dash switch controller 20 includes a first port 21 in electrical communication with the first communication path 14. The first port 21 is configured to connect with a hard wired communication node when the first communication path 14 is a hard wired serial communication bus. The dash switch controller 20 includes a second port 26 in electrical communication with an antenna module 24. The antenna module 24 may be arranged as a wireless communication node electrically connected via the second port 26, but alternatively, the antenna module 24 can be internal to the dash switch controller 20.

The dash switch controller 20 includes a third port 25 for receiving a signal indicative of a parking brake request from an external source. In one example, the dash switch controller 20 receives an electronic signal at the third port 25 from a switch 22 on the dash of the vehicle. In this example, the vehicle operator engages (e.g. pulls or pushes) the switch 22 when he desires to actuate the parking brakes on the vehicle. Alternatively, the dash switch controller 20 may receive the electronic signal indicating a parking brake request from another source, such as the vehicle controller 34 that is electrically connected to the first communication path 14. In another embodiment, the dash switch controller 20 may receive the electronic signal indicating a parking brake request communicated through the antenna module 24 from an off-vehicle device like a key fob or satellite (not shown). In another embodiment, the dash switch controller 20 may independently determine that the vehicle should be parked.

The dash switch controller 20 includes a processing unit 28, which may include volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the processing unit. The processing unit 28 includes control logic 23 and is in electrical communication with the first port 21, the second port 26 and the third port 25. One function of the control logic 23 is to receive and process information regarding requests to park or un-park the vehicle, such as from the electronic signal at the third port 25 indicating the vehicle operator's intent to park or un-park the vehicle. Another function of the control logic 23 is to receive, transmit and process information from and to the first port 21 and the second port 26. For example, information transmitted to the first port 21 by the control logic 23 includes parking brake control messages and confirmation messages. Information received at the second port 26 for the control logic 23 includes check messages, for example. Another function of the control logic 23 is to receive, transmit and process information from and to the antenna module 24. For example, information transmitted to the antenna module 24 by the control logic 23 includes parking brake control messages and confirmation messages. Information received by the antenna module 24 for the control logic 23 includes check messages.

The brake system controller 12 includes a first port 15 in electrical communication with the first communication path 14. The first port 15 is configured to connect with a hard wired communication node when the first communication path 14 is the hard-wired serial communication bus. The brake system controller 12 includes a second port 17 for communicating with an antenna module 18. The antenna module 18 may be arranged as a wireless communication node electrically connected to the second port 17, but alternatively, the antenna module 18 can be internal to the brake system controller 12.

The brake system controller 12 includes a processing unit 19, which may include volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the processing unit. The processing unit 19 includes control logic 13 and is in electrical communication with the first port 15 and the second port 17. One function of the control logic 13 is to receive, transmit and process information from and to the first port 15. For example, information received from the first port 15 for the control logic 13 includes parking brake control messages, confirmation messages and messages regarding the status of other vehicle controllers, such as vehicle controller 34, connected to the first communication path 14. Information transmitted to the first port 15 from the control logic 13 includes check messages, for example. Another function of the control logic 13 is to receive, transmit, and process information from and to the second port 17. For example, information transmitted to the second port 17 from the control logic 13 includes check messages. Information received from the second port 17 for the control logic 13 includes, for example, parking brake control messages and confirmation messages.

The brake system controller 12 optionally includes a third port 16 in electrical communication with at least one park control module 30. Alternatively, the brake system controller 12 can communicate with the park control module 30 through the first communication path 14. In one embodiment, the park control module 30 is an electro-pneumatic device with at least one solenoid 32. The park control module 30 is pneumatically connected to at least one parking brake actuator (not shown) and a source of air pressure (not shown). The park control module 30 electrically controls the solenoid 32, which opens or closes a path for air pressure. In this manner, the park control module 30 can release the vehicle parking brakes by providing air pressure to the parking brake housing portion of the at least one parking brake actuator. The park control module 30 can actuate the vehicle parking brakes by exhausting the air pressure from the parking brake housing portion of the at least one parking brake actuator. Alternatively, the functionality of a park control module can be internal to the brake system controller 12.

The brake system controller 12 optionally includes a fourth port 38 for electrically connecting to an indicator 40, such as a lamp. The indicator 40 is used to communicate to the vehicle operator the condition of the electronic parking brake system. The brake system controller 12 may also transmit an indicator message on the first communication path 14 that can be displayed to the vehicle operator on a display device (not shown) in the vehicle or remote to the vehicle.

The electronic parking brake system 10 may incorporate additional safety features whereby functions and states of other systems in the vehicle are verified prior to the actuation or release of the parking brakes. The brake system controller 12 communicates via the first communication path 14 with at least one other controller, such as vehicle controller 34 to receive information the brake system controller 12 will use in verifying whether to actuate or release the parking brakes.

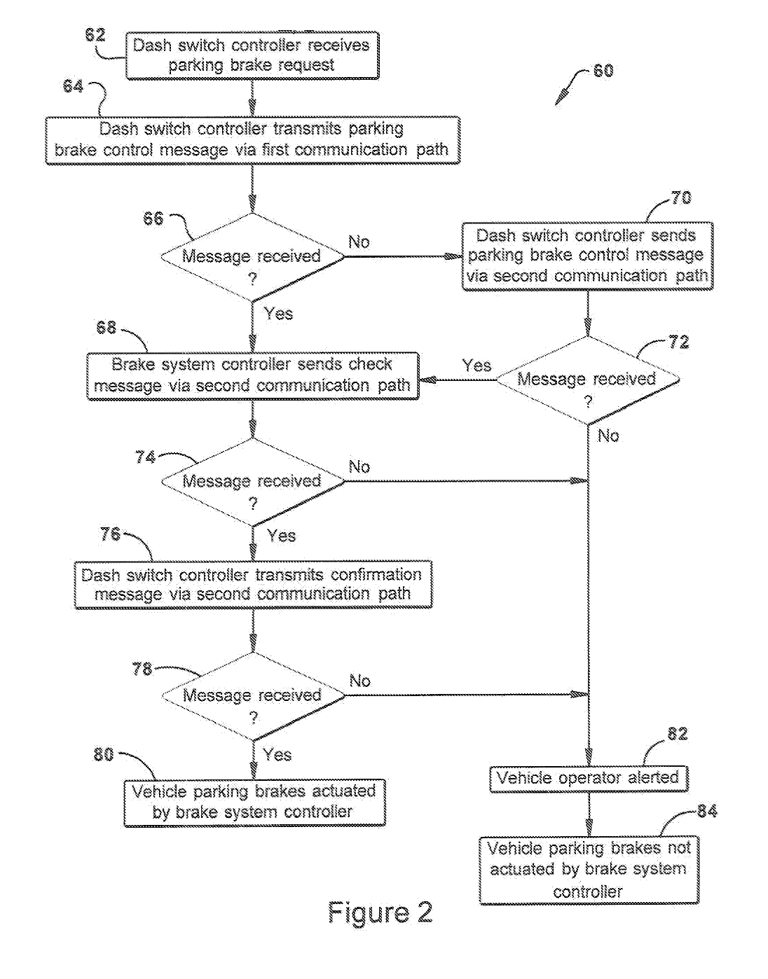

A flowchart for implementing a method 60 for parking brake actuation control according to one embodiment of the present invention is shown in FIG. 2. Implementation of the method 60 includes using the control logic 13 of the brake system controller 12 and the control logic 23 of the dash switch module 20.

The method 60 begins at step 62. In step 62, the dash switch controller 20 receives a parking brake actuation request. The parking brake actuation request can be received by the control logic 23 via the third port 25 when the operator uses the switch 22. In one embodiment, the vehicle operator requests that the parking brakes be actuated by engaging (e.g. pushing or pulling) the switch 22. Alternatively, the dash switch controller 20 may receive the parking control request from another controller, such as vehicle controller 34, via the first port 21 or from an off-vehicle source (not shown) via the second port 26. In another embodiment, the dash switch controller 20 control logic 23 may independently determine that the vehicle should be parked. The independent determination may be based on factors such as the vehicle beginning to roll down a hill during a service brake application. After the parking brake actuation request is received by the control logic 23, the method proceeds to step 64.

In step 64, the control logic 23 of the dash switch controller 20 creates a parking brake control message in response to the parking brake actuation request. The dash switch controller 20 transmits the parking brake control message via the first port 21 using the first communication path 14 to the brake system controller 12. In one embodiment, the first communication path 14 is a hard-wired serial communications bus. The method proceeds to step 66.

In step 66, a determination is made in the control logic 13 of the brake system controller 12 that a parking brake control message was received. If the control logic 13 determines that the parking brake control message was received, the method proceeds to step 68. In step 68, the brake system controller 12 transmits a check message to the dash switch controller 20 in response to the parking brake control message. The transmission is made using the second communication path 36. In one embodiment, the second communication path 36 is the wireless path wherein the brake system controller 12 uses the antenna module 18 to transmit messages. Upon receipt of the check message, the dash switch controller 20 responds to the check message via the second communication path 36. This manner of using the second communication path 36 will bypass any issues that may exist with the first communication path 14, such as a slowdown in the transmission speed due to overloading of the hard-wired serial communication bus.

Alternatively, if a first predetermined period of time has elapsed in step 66 without any response from the brake system controller 12 via the second communication path 36, the dash switch controller 20 transmits the parking brake control message via the second communication path 36 in step 70. In one embodiment, the second communication path is the wireless path wherein the dash switch controller 20 uses the antenna module 24 to transmit messages. The first predetermined time period is chosen to be at least as long as the timeout period of the communication protocol preselected for use on the first communication path 14. In one embodiment, the first predetermined period of time is less than two seconds. In this manner, once the first predetermined period of time has elapsed, the dash switch controller 20 determines that no check message is forthcoming from the brake system controller 12 via the first communication path 14 and the second communication path 36 is to be used to resend the parking brake control message.

In step 72, if the control logic 13 of the brake system controller 12 determines that the parking brake control message is received via the second communication path 36, the method proceeds to step 68.

In step 68, the brake system controller 12 transmits the check message using the second communication path 36 in response to receiving the parking brake control message either via the first communication path 14 from step 64 or via the second communication path 36 from step 70.

In step 74, the control logic 13 determines if the check message was received. If a second predetermined period of time has elapsed without any response from the dash switch controller 20, meaning that the check message was not received or the dash switch controller 20 is unable to respond, the brake system controller 12 determines that the parking brake actuation request cannot be completed using the electronic parking brake system. The second predetermined time period is chosen to be at least as long as the timeout period of the communication protocol preselected for the second communication path 36. In one embodiment, the second predetermined period of time is less than two seconds. The method proceeds to step 82 where the vehicle operator is alerted. In this instance, the brake system controller 12 is capable of alerting the operator through a signal transmitted to the fourth port 38 to an indicator 40 or through a message transmitted through the first port 15 on the first communication path 14 that can be displayed to the vehicle operator on a display device (not shown).

Upon determining the check message was received in step 74, the dash switch controller 20 then sends a confirmation message via the second communication path 36 in step 76.

In step 78, a determination is made by the control logic 13 of the brake system controller if the brake system controller 12 received the confirmation message. If the confirmation message was received, the vehicle parking brakes are actuated by the brake system controller 12 in step 80. In one embodiment, the parking brakes are actuated by transmitting a control signal from the third port 16 of the brake system controller 12 to the park control module 30. The park control module 30 in turn actuates the at least one solenoid 32 to release the air from the parking brake actuator(s) to park the vehicle.

In steps 72 and 78, if the second predetermined period of time has elapsed without any response from the brake system controller 12 to the parking brake control message from step 70 or the confirmation message from step 76, the vehicle operator is alerted in step 82. Once the vehicle operator is alerted that the dash switch controller 20 or the brake system controller 12 are not communicating according to the steps of the method 60, the brake system controller 20 does not actuate the vehicle parking brakes through the park control module 30. In one embodiment, the brake system controller 20 waits for a parking brake control message or direct communication from a source other than the dash switch controller 20 prior to actuating the vehicle parking brakes. In another embodiment, the vehicle operator is alerted through a signal transmitted to the fourth port 38 to an indicator 40 or through a message transmitted through the first port 15 on the first communication path 14 that can be displayed to the vehicle operator on a display device (not shown) so that he can intervene manually with the electronic parking brake system.

In another embodiment, subsequent communication between the dash switch controller 20 and brake system controller 12 can be completed via the second communication path 36 if the dash switch controller 20 and the brake system controller 12 determine that there is a problem with the first communication path 14. A problem, such as an intermittent connection, may cause the brake system controller 12 not to receive the parking brake control message as in step 66. Another problem may be that the protocol in which the parking control message is sent via the first communication path 14 is not the protocol in which the brake system controller 12 was preselected to communicate.

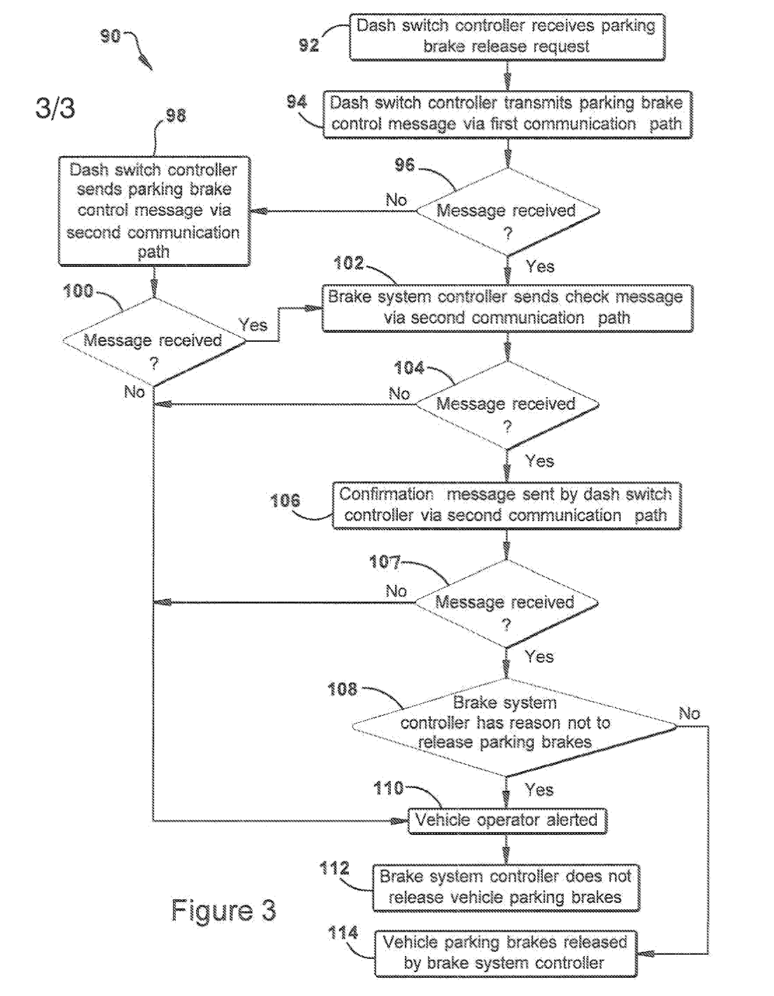

A flowchart for implementing a method 90 for parking brake release control according to another embodiment of the present invention is shown in FIG. 3. Implementation of the method 90 includes using the control logic 13 of the brake system controller 12 and the control logic 23 of the dash switch module 20.

The method 90 begins at step 92 when the dash switch controller 20 receives a request to release the parking brakes of the vehicle. The parking brake release request can be received via the third port 25 from the vehicle operator using the switch 22. In one embodiment, the vehicle operator requests that the parking brakes be released by engaging (e.g. pushing or pulling) the switch 22. Alternatively, the dash switch controller 20 may receive the parking brake release request from another controller, such as vehicle controller 34, via the first port 21 or from an off-vehicle source (not shown) via the second port 26. After the parking brake release request is received, the method proceeds to step 94.

In step 94, the control logic 23 of the dash switch controller 20 creates a parking brake control message in response to the parking brake release request. The dash switch controller 20 transmits the parking brake control message via the first port 21 using the first communication path 14 to the brake system controller 12. In one embodiment, the first communication path 14 is a hard-wired serial communications bus. The method proceeds to step 96.

In step 96, a determination is made in the control logic 13 of the brake system controller 12 that a parking brake control message was received. If the control logic 13 determines that the parking brake control message was received, the method proceeds to step 102. In step 102, the brake system controller 12 transmits a check message to the dash switch controller 20 in response to the parking brake control message. The transmission is made using a second communication path 36. In one embodiment, the second communication path 36 is the wireless path wherein brake system controller 12 uses the antenna module 18 to transmit messages. This manner of using the second communication path 36 will bypass any issues that may exist with the first communication path 14 such as a slowdown in the transmission speed due to overloading of the hard-wired serial communication bus.

Alternatively in step 96, if a first predetermined period of time has elapsed without any response from the brake system controller 12 via the second communication path 36, the method proceeds to step 98. The dash switch controller 20 transmits the parking brake release message via the second communication path 36. In one embodiment, the second communication path 36 is the wireless path wherein the dash switch module 20 uses the antenna module 24 to transmit messages. The first predetermined time period is chosen to be at least as long as the timeout period of the communication protocol preselected for the first communication path 14. In one embodiment, the first predetermined period of time is less than two seconds. In this manner, once the first predetermined period of time has elapsed, the dash switch controller 20 determines that no check message is forthcoming from the brake system controller 12 via the first communication path 14 and the second communication path 36 is used to resend the parking brake control message in step 98. The method proceeds to step 100.

In step 100, if the control logic 13 of the brake system controller 12 determines that the parking brake control message is received from the second communication path 36, the method proceeds to step 102. Otherwise, if a second predetermined second period of time has elapsed without any response from the brake system controller 12, meaning that the request was not received via the second communication path 36 or the brake system controller 12 is unable to respond, the method proceeds to step 110. The second predetermined time period is chosen to be at least as long as the timeout period of the communication protocol preselected for the second communication path 36. In one embodiment, the second predetermined period of time is less than two seconds.

In step 102, the brake system controller 12 transmits a check message to the dash switch controller 20 in response to the parking brake release message. The transmission is made using a second communication path 36. In one embodiment, the second communication path 36 is the wireless path used to transmit messages using the antenna module 18. If the second predetermined period of time has elapsed without any response from the dash switch controller 20, meaning that the request was not received via the second communication path 36 or the dash switch controller 20 is unable to respond, the method proceeds to step 110. If the control logic 23 of the dash switch controller 20 determines that the check message is received in step 104 from the second communication path 36, then the method proceeds to step 106.

In step 106, a confirmation message is transmitted by the dash switch controller 20 via the second communication path 36 to the brake system controller 12. In step 107, the control logic 13 of the brake system controller 12 determines if the confirmation message was received by the brake system controller 12. If the message was received, the method proceeds to step 108.

In step 107, if the second predetermined period of time has elapsed without any response from the brake system controller 12, the method proceeds to step 110.

In step 108, the brake system controller 12 determines if there is a reason not to release the parking brakes of the vehicle. Reasons not to release the parking brakes include unreliable communication between the brake system controller 12 and the dash switch module 20, failure of the pneumatic portion of the parking brake system or tire inflation level being too low. In step 110, the vehicle operator is alerted that the dash switch controller 20 and the brake system controller 12 are not communicating according to the steps of the method 90 or that another reason exists not to release the parking brakes. In this instance, the brake system controller 12 is capable of alerting the vehicle operator through a direct means, like indicator 40 or through a message on the first communication path 14 that can be displayed to the vehicle operator. In step 112, the brake system controller 12 maintains parking brakes of the vehicle in the actuated position.

If there is no reason not to release the parking brakes of the vehicle in step 108, the method proceeds to step 114. In step 114, the vehicle parking brakes are then released by the brake system controller 12 by transmitting a control signal from the third port 16 of the brake system controller 12 to the park control module 30. The park control module 30 in turn actuates the at least one solenoid 32 to provide the air to the parking brake actuator(s) to release the parking brakes of the vehicle.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A brake system controller comprising:
a first port;
a second port; and
a processing unit comprising control logic, the processing unit in electrical communication with the first port and the second port;
wherein the processing unit is capable of:
receiving a parking brake control message at the first port, and
transmitting a check message at the second port in response to the parking brake control message being received at the first port.

2. The brake system controller as in claim 1 wherein the processing unit is further capable of receiving a confirmation message at the second port after the check message being transmitted at the second port.

3. The brake system controller as in claim 2, the brake system controller further comprising:
a third port in electrical communication with the processing unit; wherein the processing unit is capable of transmitting a control signal at the third port in response to the confirmation message.

4. The brake system controller as in claim 2, the brake system controller further comprising a park control module, wherein the processing unit is capable of transmitting a control signal to the park control module in response to the confirmation message.

5. The brake system controller as in claim 1 wherein the first port is configured to connect with a hard wired communication node.

6. The brake system controller as in claim 5 wherein the second port is configured to connect with a wireless communication node.

7. The brake system controller as in claim 1, wherein:
the first port is configured to connect with a hard wired communication node utilizing a protocol selected from SAE J1939 and a proprietary bus protocol; and
the second port is configured to connect with a wireless communication node utilizing a protocol selected from RKE, Zigbee, BlueTooth and IEEE 802.11.

8. A dash switch controller comprising:
a first port;
a second port; and
a processing unit comprising control logic, the processing unit in electrical communication with the first port and the second port;
wherein the processing unit is capable of:
receiving a signal indicative of a parking brake request;
transmitting a parking brake control message at the first port in response to the signal indicative of a parking brake request being received;
receiving a check message at the second port after the parking brake control message being transmitted at the first port; and
transmitting a confirmation message at the second port in response to the check message.

9. The dash switch controller as in claim 8, the controller further comprising a third port in electrical communication with the processing unit; wherein the third port receives the signal indicative of a parking brake request.

10. The dash switch controller as in claim 8 wherein the first port is configured to connect with a hard wired communication node.

11. The dash switch controller as in claim 10 wherein the second port is configured to connect with a wireless communication node.

12. The brake system controller as in claim 8, wherein:
the first port is configured to connect with a hard wired communication node utilizing a protocol selected from SAE J1939 and a proprietary bus protocol; and
the second port is configured to connect with a wireless communication node utilizing a protocol selected from RKE, Zigbee, BlueTooth and IEEE 802.11.

13. An electronic parking brake system comprising:
a dash switch controller, the dash switch controller comprising a processing unit that is capable of: receiving a signal indicative of a parking brake request; transmitting a parking brake control message in response to the signal indicative of a parking brake request being received; receiving a check message after the parking brake control message is transmitted; and transmitting a confirmation message in response to the check message; and
a brake system controller communicatively coupled to the dash switch controller comprising a processing unit that is capable of: receiving a parking brake control message; and transmitting a check message in response to the parking brake control message being received.

14. The electronic parking brake system as in claim 13,
wherein the dash switch controller transmits the parking brake control message to the brake system controller using a first communication path, the brake system controller transmits the check message to the dash switch controller using a second communication path in response to the parking brake control message, the dash switch controller transmits the confirmation message to the brake system controller using the second communication path in response to the check message.

15. The electronic parking brake system as in claim 14, wherein the first communication path is a hard wired communication path; and the second communication path is a wireless communication path.

16. The electronic parking brake system as in claim 13 further comprising a park control module, wherein the brake system controller transmits a control signal to the park control module in response to the confirmation message.

17. A system to control an electronic parking brake system comprising:
a dash switch controller capable of: receiving a parking brake request; transmitting a parking brake control message on one of a first communication path and a second communication path in response to the parking brake request; receiving a check message in response to the parking brake control message; and transmitting a confirmation message on one of the first communication path and the second communication path in response to the check message;
a brake system controller capable of: receiving the parking brake control message; transmitting the check message on one of the first communication path and the second communication path; and receiving the confirmation message in response to the check message;
means for communicating the parking brake control message, the confirmation message and the check message between the dash switch controller and the braking system controller; and
means for determining the parking brake control message was received by the brake system controller prior to the brake system controller controlling a park control module.

18. A method for controlling an electronic parking brake system comprising:
receiving in a dash switch controller a parking brake request;
transmitting a parking brake control message from the dash switch controller to a brake system controller through a first communication path in response to the parking brake request;
receiving a check message from the brake system controller to the dash switch controller through a second communication path in response to the parking brake control message, wherein the first communication path is different than the second communication path;
transmitting a confirmation message from the dash switch controller to the brake system controller through the second communication path in response to the check message.

19. The method as in claim 18 wherein the parking brake request is initiated by a source external to the dash switch controller.

20. The method as in claim 18 further comprising transmitting a control signal from the brake system controller to a park control module in response to the confirmation message.

21. The method as in claim 18 wherein the first communication path comprises a hard-wired communication path.

22. The method as in claim 21 wherein the second communication path comprises a wireless communication path.

23. The method as in claim 18 wherein:
the dash switch controller does not receive the check message in a first predetermined period of time and transmits the parking brake control message through the second communication path.

24. The method as in claim 23 wherein:
the brake system controller does not receive the confirmation message from the dash switch controller in a second predetermined period of time after transmitting the check message; and
the brake system controller transmits an alert.

25. The method in claim 18 wherein subsequent parking brake control messages from the dash switch controller to the brake system controller are transmitted through the second communication path in response to the brake system controller not receiving a parking brake control message through the first communication path.

26. A method for controlling an electronic parking brake system comprising:
receiving in a dash switch controller a parking brake request;
communicating from the dash switch controller to a brake system controller a parking brake control message using a first communication path in response to the parking brake request;
communicating from the brake system controller to the dash switch controller a check message using a second communication path in response to the parking brake control message, wherein the first communication path is different from the second communication path; and
communicating from the dash switch controller to the brake system controller a confirmation message using the second communication path, the brake system controller controlling the electronic parking brake system in response to the parking brake control message and the confirmation message.

27. A method for communicating a parking brake control request, the method comprising:
transmitting a parking brake control message from a dash switch controller to a brake system controller using a first communication path;
determining whether the dash switch controller receives a check message in response to the parking brake control message;
transmitting the parking brake control message through a second communication path if the brake system controller does not receive the parking brake control message within a predetermined period of time after transmitting the parking brake control message;
transmitting a check message using the second communication path from the brake system controller in response to the brake system controller receipt of the parking brake control message; and
receiving the confirmation message at the brake system controller, the brake system controller controlling the parking brakes in response to the parking brake control message.
